(19) United States
(12) Patent Application Publication
(10) Pub. No.: US 2018/0299105 A1
(43) Pub. Date: Oct. 18, 2018

(54) WALL LAMP MOUNTING PLATE AND WALL LAMP MOUNTING ASSEMBLY

(71) Applicant: DONGGUAN THAILIGHT SEMICONDUCTOR LIGHTING CO., LTD, DONGGUAN (CN)

(72) Inventor: Wenbo ZHOU, DONGGUAN (CN)

(73) Assignee: DONGGUAN THAILIGHT SEMICONDUCTOR LIGHTING CO., LTD, DONGGUAN (CN)

(21) Appl. No.: 15/683,783

(22) Filed: Aug. 23, 2017

(30) Foreign Application Priority Data
Apr. 18, 2017 (CN) 201720407450.1

(51) Int. Cl. F21V 21/02; F21S 8/00; F21S 8/02

(52) U.S. Cl. CPC F21V 21/02; F21V 19/00; F21S 8/02; F21S 8/036

(57) ABSTRACT

The present invention discloses a wall lamp mounting plate and a wall lamp mounting assembly. The wall lamp mounting plate includes a body. The body is a flat plate. The body is provided with a plurality of arcuate holes and a plurality of mounting holes. The centers of the plurality of mounting holes are located on the same circumference. Two ends of the body are bent outwardly to form a first bent portion and a second bent portion. The first bent portion and the second bent portion are located on the same side of the body. The wall lamp mounting assembly includes a wall lamp mounting plate, a junction box, long screw, and a wall lamp. The wall lamp mounting plate includes a body. The body is fixedly connected to the junction box.

### CROSS REFERENCE

This application claims priority to Chinese Patent Application No. 201720407450.1, filed on Apr. 18, 2017, the entire contents of which are incorporated herein by reference.

### TECHNICAL FIELD

The present invention relates to light fixture accessories, particularly to a wall lamp mounting plate.

### BACKGROUND OF THE INVENTION

With the widespread use of lamps, people demand a lot of new requirements for the lamp. Currently, the wall lamps are usually fixed onto the wall through the fasteners such as screws and so on. The complex process of mounting and dismounting requires a lot of effort for the replacement of the lamp. The requirement for replacing various lamps is hard to be satisfied. In addition, the existing mounting plate structures are highly specified and need to fit the junction box having a specific structure. Once the junction box is installed on the wall, the installation of the wall lamp need to be achieved by purchasing the specific mounting board, which causes troubles to the user during interior decoration.

### SUMMARY OF THE INVENTION

In order to overcome the drawbacks of the prior art, the present invention aims to provide a wall lamp mounting plate and a wall lamp mounting assembly, which are easy to mount and dismount. The replacement of the lamp is convenient.

The objectives of the present invention are realized by the following technical solutions:

A wall lamp mounting plate is provided. The wall lamp mounting plate includes a body. The body is a flat plate. The body is provided with a plurality of arcuate holes and a plurality of mounting holes. The centers of the plurality of mounting holes are located on the same circumference. The plurality of arcuate holes are arranged in groups. The different groups of arcuate holes are circumferentially arranged in an array. Each mounting hole is located between two adjacent groups of the arcuate holes. Two ends of the body are bent outwardly to form a first bent portion and a second bent portion. The first bent portion and the second bent portion are located on the same side of the body.

Furthermore, the second bent portion is provided with a recess. Two hooks are arranged inside the recess. The bent points of the two hooks are located in the same horizontal plane.

Furthermore, the plurality of mounting holes are four mounting holes. Each mounting hole is strip-shaped. Two ends of each mounting hole are transited by arc.

Furthermore, the mounting holes are round-shaped or ellipse-shaped.

Furthermore, a spacing between two adjacent arcuate holes of the same group has a same or different distance.

Furthermore, three arcuate holes make up a group. There are four groups in total.

A wall lamp mounting assembly is provided. The wall lamp mounting assembly includes a wall lamp mounting plate, a junction box, at least one long screw, and a wall lamp. The wall lamp mounting plate includes a body. The body is fixedly connected with the junction box. Two ends of the body are bent to form a first bent portion and a second bent portion. A side of an opening end of the wall lamp pushes against the first bent portion under an action of gravity, such that the wall lamp is hung on the wall lamp mounting plate. The at least one long screw passes through the other side of the opening end of the wall lamp and pushes against the second bent portion, so as to reinforce a connection between the wall lamp and the wall lamp mounting plate.

Furthermore, the first bent portion and the second bent portion are located on a same side of the body and are bent outwardly. The second bent portion is provided with a recess. Two hooks are arranged inside the recess. Two bent points of the two hooks are located in the same horizontal plane.

Furthermore, the body is a flat plate. The body is provided with a plurality of arcuate holes and a plurality of mounting holes. The centers of the plurality of mounting holes are located on the same circumference. The plurality of arcuate holes are arranged in groups. Different groups of arcuate holes are circumferentially arranged in an array. Each mounting hole is located between two adjacent groups of the arcuate holes.

Compared with the prior art, the advantages of the present invention are as follows. When the wall lamp is hung on the mounting plate, a stable connection between the wall lamp and the mounting plate can be achieved by tightening the long screws. The wall lamp can be dismounted from the mounting plate by releasing the long screws. Thus, the connection is stable, the mounting and dismounting are easy, and the replacement of the lamp is easy.

### BRIEF DESCRIPTION OF THE DRAWINGS

FIG. 1 is a perspective view of a wall lamp mounting plate of the present invention;

FIG. 2 is a top view of the wall lamp mounting plate shown in FIG. 1;

FIG. 3 is a schematic view of the usage of the wall lamp mounting plate shown in FIG. 1.

In the drawings: 100, wall lamp mounting plate; 1, body; 11, round hole; 12, mounting hole; 13, arcuate hole; 14, first bent portion; 15, second bent portion; 16, recess; 17, hanging hook; 200, wall lamp; 300, long screw.

### DETAILED DESCRIPTION OF THE INVENTION

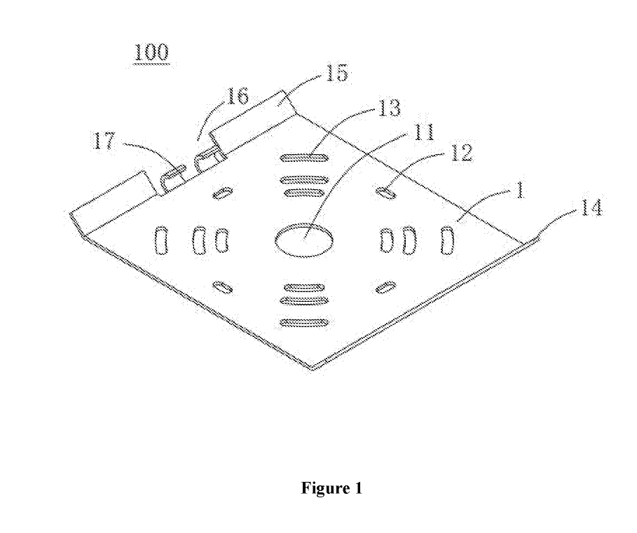

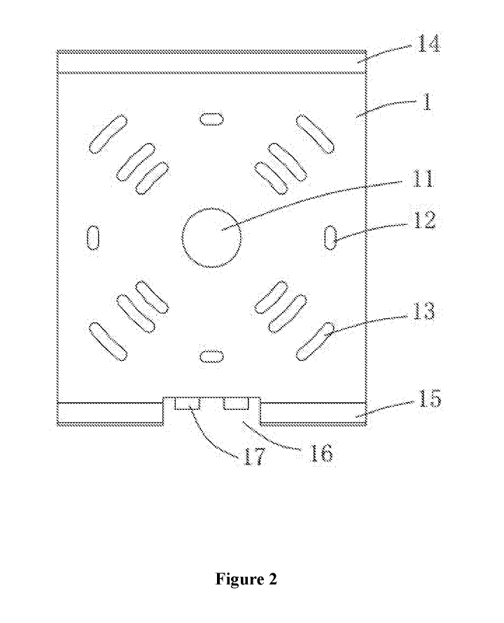

The present invention will be further described with reference to the drawings and the specific embodiments hereinafter. As shown in FIGS. 1-2, a wall lamp mounting plate 100 includes body 1. Body 1 is a flat plate, so as to facilitate the fitting to the wall. In the present embodiment, body 1 is rectangle-shaped. In other embodiments, the shape of body 1 can be round, square, irregular polygon, etc.

The center of body 1 is provided with round hole 11, through which the power lines in the junction box (not shown) pass. Body 1 is further provided with a plurality of mounting holes 12 and a plurality of arcuate holes 13. Mounting hole 12 and arcuate hole 13 both can be used as a screw assembling hole to realize a fixed connection between wall lamp mounting plate 100 and the junction box (not shown). The plurality of mounting holes 12 and the plurality of arcuate holes 13 are provided for the connection to the junction boxes having different sizes.

The distance between the center of each mounting hole 12 and the center of body 1 is the same, namely, the center of each mounting hole 12 is located on the same circumference with the center of body 1 as the center of the circle. The plurality of mounting holes 12 are circumferentially distributed in an array with respect to the center of body 1. Wall lamp mounting plate 100 can be fixed to the junction box (not shown) by mounting screws in mounting hole 12. The arrangement of a plurality of mounting holes 12 can effectively ensure the fixation strength. In the present embodiment, the mounting hole 12 is strip-shaped, wherein two ends of the mounting hole are transited by arc. There are four mounting holes. In other embodiments, the shape of mounting hole 12 can be round, square, ellipse or other shapes. The number of the mounting holes can be increased or reduced, such as two, three, five and the like.

The arcuate hole 13 can reduce the weight of the wall lamp mounting plate 100, the material consumption, and costs. Arcuate hole 13 can be used as a screw mounting hole during the installation of wall lamp 200. Three arcuate holes 13 make up a group. There are four groups in total. The four groups of arcuate holes 13 are circumferentially arranged in array. Mounting hole 12 is provided between two adjacent groups of arcuate holes 13. The spacing among three arcuate holes 13 in the same group is the same or different. The number of arcuate holes 13 in each group may also be two, four, etc., which is not limited to the numbers listed in this embodiment.

Two ends of body 1 are bent outwardly to form first bent portion 14 and second bent portion 15. First bent portion 14 and second bent portion 15 are located on the same side of body 1. Recess 16 is arranged in the middle of second bent portion 15. Two hanging hooks 17 are arranged inside recess 16. Two hanging hooks 17 are used for holding the horizontal bubble to calibrate the level of the wall lamp 200 after installation to ensure that the wall lamp 200 is installed in the position that meets the requirements.

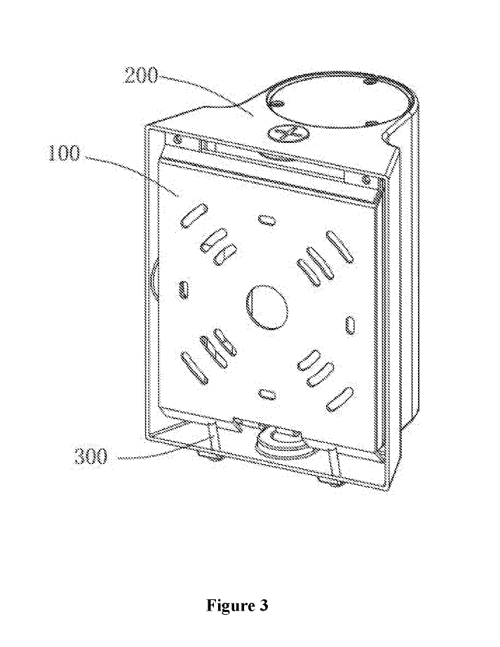

Further referring to FIG. 3, in practice, the junction box (not shown) is firstly installed in the wall, wherein power lines are mounted inside the junction box (not shown). Subsequently, the screws pass through mounting hole 12 or arcuate hole 13 such that wall lamp mounting plate 100 is fixedly mounted on the junction box (not shown). After installation, hanging hook 17 is located at a lower position. The opening end of wall lamp 200 is hung on first bent portion 14. The inner wall of the opening end of wall lamp 200 pushes against first bent portion 14 under the action of gravity. Two long screws 300 pass through the bottom of wall lamp 200. Two long screws 300 are tightened to push against second bent portion 15. Accordingly, under the action of the tightening force of long screw 300, wall lamp 200 is hung on wall lamp mounting plate 100 firmly. While dismounting, wall lamp 200 hung on wall lamp mounting plate 100 can be removed by releasing the long screw 300. As such, the replacement of the lamp is easy.

Those skilled in the art can make various other modifications and variants with reference to the technical solutions and concepts described above. However, all these modifications and variants should fall within the scope of the present invention as defined by the appended claims.

What is claimed is:

1. A wall lamp mounting plate, comprising:
a body;
wherein
the body is a flat plate;
the body is provided with a plurality of arcuate holes and a plurality of mounting holes;
centers of the plurality of mounting holes are located on a same circumference;
the plurality of arcuate holes are arranged in groups;
different groups of arcuate holes are circumferentially arranged in an array;
each mounting hole is located between two adjacent groups of the arcuate holes;
two ends of the body are bent outwardly to form a first bent portion and a second bent portion; and
the first bent portion and the second bent portion are located on a same side of the body.

2. The wall lamp mounting plate of claim 1, wherein
the second bent portion is provided with a recess;
two hooks are arranged inside the recess; and
two bent points of the two hooks are located in a same horizontal plane.

3. The wall lamp mounting plate of claim 1, wherein
the plurality of mounting holes are four mounting holes;
each mounting hole is strip-shaped; and
two ends of each mounting hole are transited by an arc.

4. The wall lamp mounting plate of claim 1, wherein the mounting holes are round-shaped or ellipse-shaped.

5. The wall lamp mounting plate of claim 1, wherein a spacing between two adjacent arcuate holes of the same group has a same or different size.

6. The wall lamp mounting plate of claim 5, wherein three arcuate holes make up a group; and
there are four groups in total.

7. A wall lamp mounting assembly, comprising:
a wall lamp mounting plate,
a junction box,
at least one long screw, and
a wall lamp;
wherein
the wall lamp mounting plate includes a body;
the body is fixedly connected with the junction box;
two ends of the body are bent to form a first bent portion and a second bent portion;
a side of an opening end of the wall lamp pushes against the first bent portion under an action of gravity, such that the wall lamp is hung on the wall lamp mounting plate; and
the at least one long screw passes through an other side of the opening end of the wall lamp and pushes against the second bent portion, so as to reinforce a connection between the wall lamp and the wall lamp mounting plate.

8. The wall lamp mounting assembly of claim 7, wherein
the first bent portion and the second bent portion are located on a same side of the body and are bent outwardly;
the second bent portion is provided with a recess;
two hooks are arranged inside the recess; and
two bent points of the two hooks are located in a same horizontal plane.

9. The wall lamp mounting assembly of claim 7, wherein
the body is a flat plate;
the body is provided with a plurality of arcuate holes and a plurality of mounting holes;
centers of the plurality of mounting holes are located on a same circumference;
the plurality of arcuate holes are arranged in groups;
different groups of the plurality of arcuate holes are circumferentially arranged in an array; and
each mounting hole is located between two adjacent groups of the plurality of arcuate holes.
